(19) United States
(12) Patent Application Publication
(10) Pub. No.: US 2020/0281171 A1
(43) Pub. Date: Sep. 10, 2020

(54) DEVICE FOR REARING AQUACULTURE ANIMALS AT SEA

(71) Applicant: GENOCEAN, Saint-Martin-de-Ré (FR)

(72) Inventors: Eric Marissal, Saint-Martin-de-Ré (FR); Lila Pincot, La Flotte (FR)

(21) Appl. No.: 16/759,321

(22) PCT Filed: Oct. 26, 2018
(86) PCT No.: PCT/EP2018/079454

§ 371 Date: Apr. 24, 2020

(30) Foreign Application Priority Data
Oct. 27, 2017 (FR) 1760136

(51) Int. Cl. A01K 61/65; A01K 61/55

(52) U.S. Cl. CPC A01K 61/65; A01K 61/55

(57) ABSTRACT

A rearing device including a framework, at least one rearing enclosure internally delimiting a volume for receiving aquaculture animals, a float device connected to the at least one rearing enclosure, a connection connecting the at least one rearing enclosure to the framework, permitting a rotation of the at least one rearing enclosure with respect to the framework about at least one substantially horizontal axis of rotation, and a limiting device limiting travel of the at least one rearing enclosure relative to the framework along the vertical direction.

### CROSS-REFERENCE TO RELATED APPLICATIONS

This application claims benefit under 35 USC § 371 of PCT Application No. PCT/EP2018/079454 entitled DEVICE FOR REARING AQUACULATURE ANIMALS AT SEA, filed on Oct. 26, 2018 by inventors Eric Marissal and Lila Pincot. PCT Application No. PCT/EP2018/079454 claims priority of French Patent Application No. 17 60136, filed on Oct. 27, 2017.

### FIELD OF THE INVENTION

The invention generally relates to devices for rearing aquaculture animals at sea, in particular shellfish and more particularly oysters.

### BACKGROUND OF THE INVENTION

In the majority of oyster farming countries, oysters are consumed shucked. There cooked before being consumed. In France, and in other countries, the oysters are consumed alive in their shells. These two different consumption modes have contributed to two different rearing types. Indeed, raw consumption in the shell requires irreproachable quality in the shape of the latter, less importance being given to the quality of the meat. To consume the shucked meat, no importance is given to the shape of the oyster.

Thus, in shucked consumption, the consumer requires a very meaty fish, which may retain a certain volume and texture after cooking, like for mussels. In the overwhelming majority of cases, the oysters are then reared in open water, adhered on their original support up to a sufficient size and age. They are harvested in appropriate periods for the quantity of meat and quality of fattening to meet consumer expectations.

In the case of oysters consumed raw in their shells, zootechnics have turned toward rearing oysters one by one, in enclosures able to be shaken regularly to prevent them from sticking to one another.

In order to allow these manipulations, the rearing areas are delimited exclusively in the intertidal area allowing access at low tide by personnel responsible for mixing the enclosures. These enclosures are generally pouches made from plastic mesh, placed on tables made from steel bars anchored on the beach. Thus concentrated and manipulated, the oysters grow correctly, but only very rarely achieve a meat quality equivalent to what the informed consumer is seeking, the latter being accustomed to consuming shucked oysters.

The drying area, that is to say, the intertidal area, is characterized by the strength of the waves, which in turn depends on the exposure of the coastline in question to the wind and the swell of the sea. On rare sites, it is thus possible, due to particularly powerful and regular mixing by the waves, to obtain not only oysters that are rolled enough in the rearing pouches for their shells to be eroded, rounded and well hollowed out, but also to have an exceptional meat content. These oysters are described as “super special”. The phenomenon involved is simple: when the food capacity of the oyster is satisfied, it always, up to a certain age (3 years), favors the allocation of energy to shell growth, to the detriment of fattening. On sites that are highly exposed to the waves, the fact that the shells are rolled in the rearing enclosures very regularly during the ebb tide, when the enclosures emerge in the waves, makes it possible to break part of the daily shell growth and to require the animal to favor growth of the shell in terms of thickness, which is slower, but guarantees a hollow and rounded shape. This operation would be impossible to do by hand because of the operating time at low tide, in light of the time needed by the personnel to perform it on large rearing areas.

At the same time, the proportion of energy not allocated to shell growth is reoriented toward fattening, thus favoring a high meat content, characterized by the “super special” quality.

This quality can be quantified as a filling rate of the mantle cavity of 60% after opening and 10 minutes of drainage. This combination of quality of shape and high meat content constitutes the very top of the line, which, consumed raw, is greatly appreciated by consumers in countries around the world.

Unfortunately, the sites where this rolling work of the shells is performed naturally in conventional enclosures of the oyster farming pouch type are rare. These sites must in fact have rich enough food and strong and constant enough agitation, but without being excessive, in order to avoid total destruction of the rearing site in case of storm.

For several years, a number of oyster farmers have had the idea to create so-called hanging rearing enclosures, of the swing chair type, in which the oysters would be more easily set in motion than in the oyster farming pouches conventionally fastened on the tables.

The enclosures are suspended from cables stretched horizontally, or below steel bars supported by oyster farming tables. They are very mobile, and are therefore able to transfer, to the oysters that they contain, the movement imparted by the marine currents and by waves of lesser amplitude than those necessary for the mixing of the oysters in the fixed enclosures.

There are several models of hanging enclosures: most are tubular enclosures, which may or may not be provided with a door at one of their ends, and suspended from cables fastened to their apex.

These models have a number of serious handicaps, which limit their usage tremendously.

These enclosures are very fragile. They are effective to mix oysters under moderately harsh conditions (sea current, swell, etc.), but do not withstand the harsh conditions accepted by fixed enclosures. They are therefore only usable in a semi-lagoonal, protected environment, and therefore can only be used in a very small proportion of oyster rearing sites to produce oysters in the French style.

Secondly, in light of the oscillating movement, all of these enclosures have spontaneously been designed with a cylindrical shape that leaves only a small surface area available for a significant mass of oysters. Indeed, the oysters accumulating at the lowest point of the enclosure, they have a small surface area to spread out. Once the growth is sufficient to fill half the enclosure, the oysters pile up and the movements are no longer sufficient to roll the oysters. The rearing naturally reorients itself toward a deterioration of the shell and meat quality.

Third, a secondary consequence of the cylindrical shape is the stacking of the oysters, the latter not being able to roll in the enclosure unless the agitation conditions are very strong. This is fairly incompatible with the fragility of the material.

Fourth, these cylindrical enclosures have a significant bulk, and therefore take up tremendous storage space. This limits the transport capacity of the oysters, and complicates the possibility of stacking the enclosures in a stable manner on ships or handling trailers compared with the flat oyster farming pouches, which stack easily and have only a slightly larger volume than that of the transported oysters.

Fifth, these enclosures are very difficult to clean, since they have a multitude of faces and an inner volume that is inaccessible to the washing jet.

Sixth, they cannot be turned over, and therefore are dirtied by algae on the illuminated face and by ascidians on the bottom face, sheltered from the sun. This quickly causes the mesh to be covered, thus depriving the oysters inside from the flow of water necessary for them to be properly fed.

To address part of the above difficulties, FR 2,576,484 proposes to add a float to the outside of the enclosure. Thus, the enclosure turns over between the high tide, during which it floats, and the low tide, during which it hangs. It is clear that this turning over allows better mixing of the oysters, in particular upon the emergence at ebb tide.

However, the farmer cannot easily adapt this system to the hydraulic conditions prevailing in the rearing zone and to the seasonality of the rearing.

### SUMMARY OF THE DESCRIPTION

In this context, the invention aims to propose a rearing device at sea that procures better mixing and that is more easily adaptable.

To that end, the invention relates to a device for rearing aquaculture animals at sea, the device comprising:
a chassis;
at least one rearing enclosure internally delimiting a volume for receiving the aquaculture animals;
a float device connected to said at least one rearing enclosure;
a connection connecting said at least one rearing enclosure to the framework, permitting a rotation of said at least [one] rearing enclosure with respect to the framework about at least one substantially horizontal axis of rotation;
a limiting device limiting the travel of said at least one rearing enclosure relative to the framework along the vertical direction.

The limiting device makes it possible to limit the vertical amplitude of the movement, which allows the farmer to adapt the system to the hydraulic conditions prevailing in the rearing zone and to the seasonality of the rearing.

The greater the vertical amplitude of the movement of the rearing enclosures is, the greater the agitation duration and the more violent the agitation.

It should be noted that the limiting device also makes it possible to adjust the amplitude and duration of agitation of the aquaculture animals, in order to regulate the desired effect on the rearing animals.

The device may further have one or more of the features below, considered individually or according to any technical possible combination(s):
the limiting device comprises at least one flexible link connecting the framework to said at least one rearing enclosure, the at least one flexible link preferably being resilient.
said at least one rearing enclosure has a proximal edge and a distal edge that are opposite one another, the connection connecting the proximal edge to the framework, said at least one flexible link preferably connecting the distal edge to the framework;
the float device is connected to a zone of said at least one rearing enclosure located near the distal edge;
the framework comprises several metal bars parallel to one another and spaced apart from one another at least horizontally, the rearing devices comprising several rearing enclosures each positioned between two of the metal bars, the proximal edge of said rearing enclosure being connected by the connection to one of the two metal bars, the distal edge of said rearing enclosure being connected by the flexible link to the other of the two metal bars;
the framework comprises several metal bars parallel to one another and spaced apart from one another at least vertically, the rearing device comprising several rearing enclosures located one above the other, each connected to one of the metal bars, all of the rearing enclosures being connected to a same float device;
a first flexible link connects the upper rearing enclosure to the framework, limiting the downward travel of the rearing enclosures;
a second flexible link connects one of the rearing enclosures to the framework, limiting the upward travel of the rearing enclosures;
the connection permits a rotation of said at least one rearing enclosure about a first, substantially horizontal axis of rotation, and a rotation of the first axis of rotation with respect to the framework about a second axis of rotation substantially parallel to the first axis of rotation;
the connection includes at least one connection member of the connecting rod type, mounted pivoting on said at least one rearing enclosure about the first axis of rotation and mounted pivoting on the framework about the second axis of rotation;
said at least one rearing enclosure has a substantially flat lower bottom, parallel to the first and second axes of rotation.

### BRIEF DESCRIPTION OF THE DRAWINGS

Other features and advantages of the invention will emerge from the detailed description thereof provided below, for information and non-limitingly, in reference to the appended figures, in which:

FIG. 1 is a simplified schematic illustration a rearing device according to a first embodiment of the invention;

FIG. 2 schematically shows the upward movement of one of the rearing enclosures of the device of FIG. 1,

FIG. 3 illustrates the downward movement of the same rearing enclosure;

FIG. 4 is a more precise illustration of several enclosures of the rearing device of FIG. 1, in top view;

FIGS. 5 and 6 are front and side views, respectively, of a half-enclosure used to form the enclosures of FIG. 4;

FIGS. 7 and 8 are enlarged views of details of the half-enclosure of FIGS. 5 and 6;

FIG. 9 is a side view of a connecting member of the device of FIG. 4, before fastening to the rearing enclosure;

FIGS. 10 to 12 are perspective views of the connecting member of the device of FIG. 9, respectively, mounted on the rearing enclosure, in the stable open position, and closed around the framework;

FIG. 13 is a top view of the connecting member of FIG. 12, after fastening to the rearing enclosure and the framework;

FIG. 14 is a perspective view of one of the rearing enclosures of FIG. 4, showing the reinforced stop zones and the blocking members;

FIG. 15 is a simplified schematic perspective illustration of the rearing device of FIG. 1, showing how it is possible to turn over the rearing enclosures;

FIG. 16 illustrates a second embodiment of the invention, in a situation where the float is located at mid-tide at the surface of the sea;

FIGS. 17 and 18 are schematic side illustrations of the rearing device of FIG. 16, at high tide and at low tide;

FIG. 19 illustrates how different rearing devices according to FIG. 16 can be positioned along the tidal zone;

FIG. 20 illustrates a variant of the second embodiment, in which the system ensuring the hanging of the enclosures comprises a string of floats positioned in the intertidal zone and an inner float housed in each enclosure;

FIG. 21 illustrates another arrangement mode of the frameworks on which the enclosures are mounted.

### DETAILED DESCRIPTION

The invention relates to a device for rearing aquaculture animals at sea. These animals are typically shellfish, and are more particularly oysters. In a variant, the shellfish are all types of bivalves such as clams, mussels, or any other type of shellfish.

This device is provided for rearing at sea. This rearing can be done offshore from coasts or in sluices, estuaries or rias, or in ponds communicating with the sea, or in any other appropriate location.

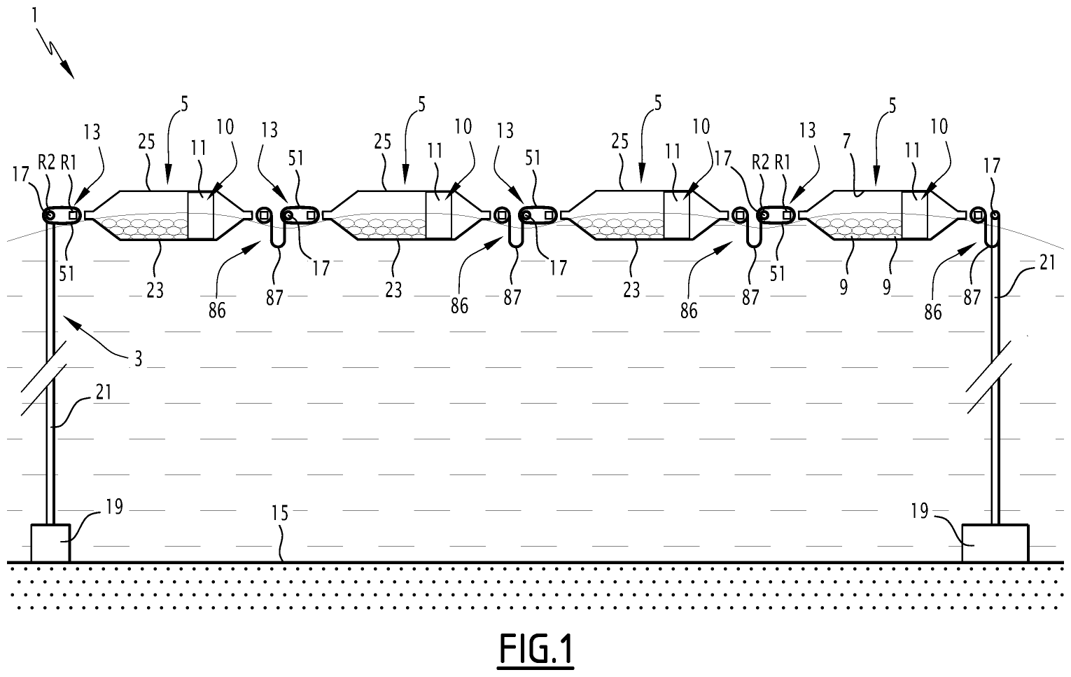

As illustrated in FIGS. 1 to 3, the rearing device 1 comprises:
a framework 3;
at least one rearing enclosure 5 internally delimiting a volume 7 for receiving the aquaculture animals 9;
a float device 10 connected to said at least one rearing enclosure 5;
a connection 13 connecting said at least one rearing enclosure 5 to the framework 3.

The framework 3 is provided to be placed at the bottom of the sea. Typically, it rests on the bottom 15 of the sea. It is stationary relative to the sea bed 15.

In the first embodiment, the framework 3 includes a plurality of metal bars 17 that are parallel to one another and spaced apart from one another at least horizontally.

For example, the metal bars 17 are placed at the same distance from the bottom 15.

The framework 3 for example includes ingots 19 resting on the sea bed 15, supporting rigid posts 21 to which the metal bars 17 are rigidly fastened. The metal bars 17 are regularly spaced apart from one another along a direction that is horizontal in FIG. 1.

In the first embodiment, the rearing device includes a plurality of rearing enclosures 5, each positioned between two metal bars 17.

Each rearing enclosure 5 has a lower bottom 23, which is substantially flat.

It preferably has a substantially flat upper bottom 25, which is parallel to and opposite the lower bottom 23.

The lower and upper bottoms 23, 25 have a determined separation between them. This separation is taken along a direction substantially perpendicular to the two bottoms.

The lower and upper bottoms 23, 25 also each have a length and a width greater than three times said separation. The length is taken along a direction contained in the plane in which the upper or lower bottom fits. The width is taken along a direction contained in said plane and perpendicular to the length.

Preferably, the length and the width are greater than five times the separation, still more preferably greater than ten times the separation.

Thus, the rearing enclosure has a flat general shape, and has a large surface area in light of its thickness. It thus has the general shape of a pouch typically used for rearing oysters.

For example, the rearing enclosure has a length on the order of 1 meter, a width on the order of 500 mm, and a height on the order of 50 mm.

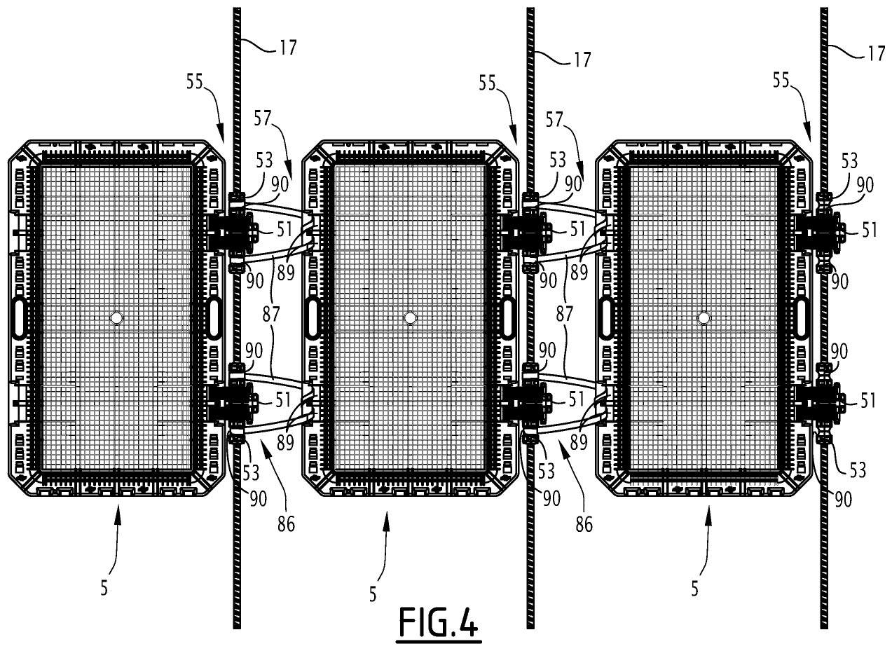

As shown in FIGS. 4 to 6, the rearing enclosure preferably comprises two half-enclosures 27, one defining the lower bottom 23 and the other the upper bottom 25.

The two half-enclosures together delimit the volume 7 for receiving aquaculture animals.

They are fastened to one another removably, using means that will be described later.

Advantageously, the two half-shells 27 are identical to one another.

They are preferably made from a plastic material, for example from polypropylene.

They are typically obtained by injection of the plastic material. The fact that the two half-enclosures are identical to one another therefore makes it possible to manufacture the two half-enclosures with the same mold, and therefore allows a particularly economical production.

The half-enclosures 27 have a generally concave shape. The concavities of the two half-enclosures face toward one another when they are fastened to one another in order to form the rearing enclosure.

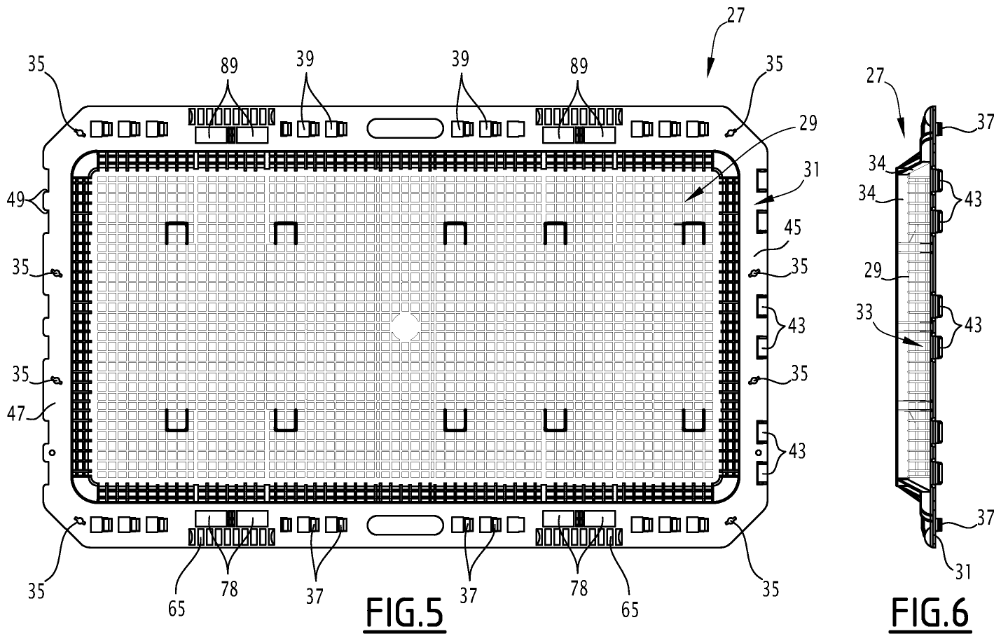

Each half-enclosure 27 comprises a substantially planar part 29 defining the upper bottom or the lower bottom depending on the case, an annular flat edge 31 surrounding the planar part 29, and a wall with a closed contour 33 connecting the planar part 29 to the flat edge 31 (FIGS. 5 and 6). The wall with a closed contour 33 connects an outer edge of the planar part 29 to an inner edge of the flat edge 31. In other words, the flat edge 31 forms a collar, extending outward from the wall 33.

The flat edge 31 fits in a plane parallel to the planar part 29, defining the contact plane between the two half-enclosures when they are assembled to make up the rearing enclosure.

The planar part 29 and the side wall 33 are pierced with multiple openings, not referenced, small enough that the aquaculture animals cannot escape from the rearing enclosure, but large enough to allow water to circulate between the inside and the outside of the rearing enclosure.

The planar part 31 and the side wall 33 are reinforced by ribs 34.

Advantageously, the two half-shells 27 can be nested in one another. This makes it possible to stack a large number of half-enclosures and to store them in a smaller volume.

To do this, the side wall 33 is flared, and diverges from the planar part 29 toward the flat edge 31.

In the illustrated example, the planar part 29 is rectangular, and the flat edge 31 is delimited by a rectangular outer edge and by an inner edge that is also rectangular.

In a variant, the planar part 29 and the flat edge 31 have any appropriate shape: square, circular, oval, etc.

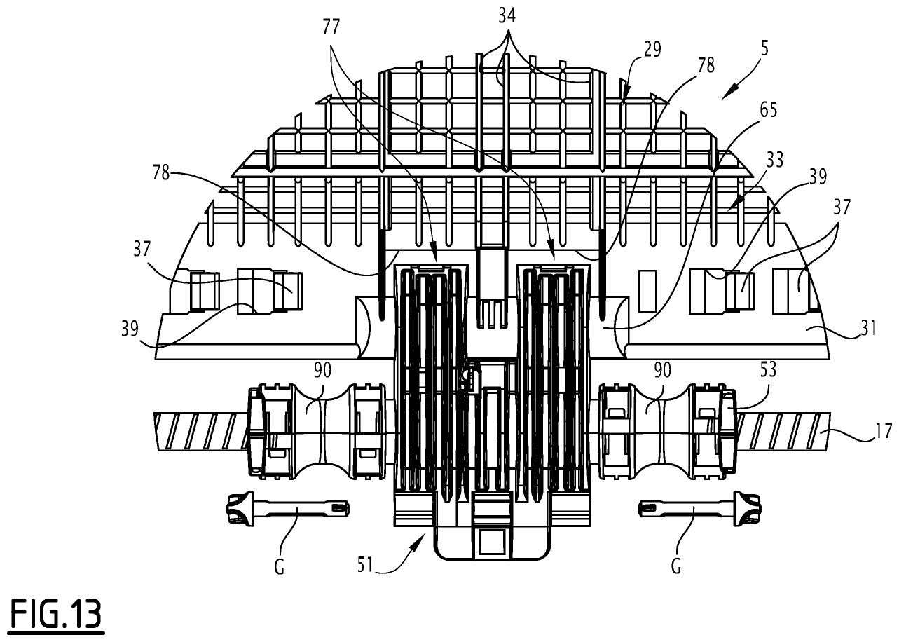

Preferably, the two half-enclosures 27 are fastened to one another by blocking members, typically pins 36 shown in FIG. 14. To that end, the flat edge 31 has slits 35 distributed on at least two opposite sides of the planar part 29. The slits 35 are provided to receive the blocking members. To make up the rearing enclosure 5, the two half-enclosures 27 are placed with their respective edges 31 against one another. The slits 35 of the two half-enclosures then coincide and it is possible to engage the blocking members there.

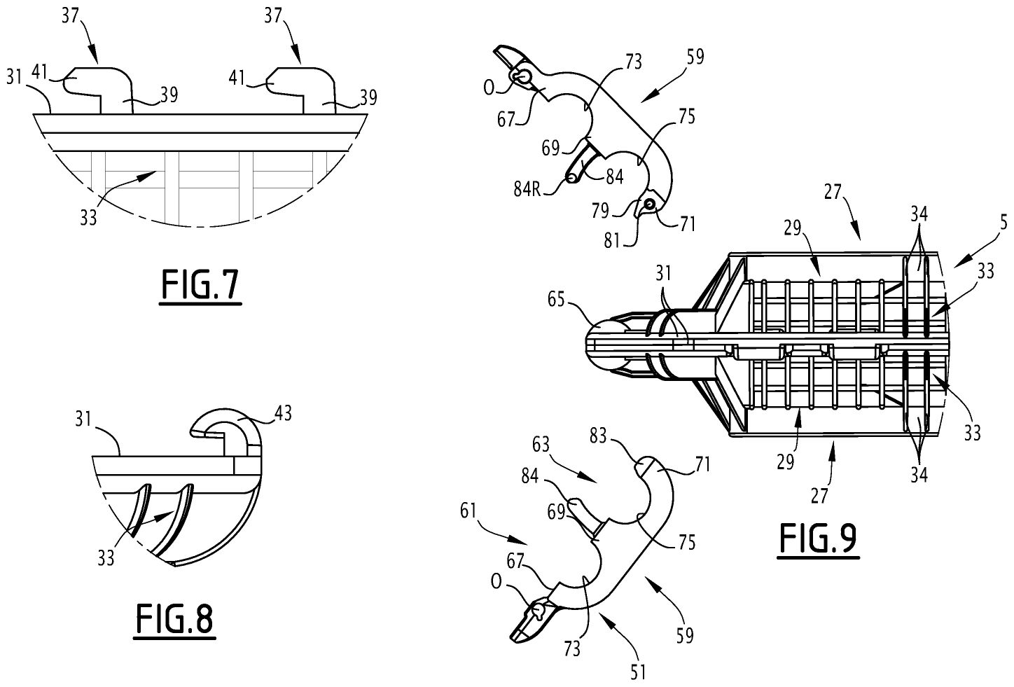

In order to strengthen the fastening of the two half-enclosures 27 to one another, each half-enclosure includes hooks 37 (FIG. 7) and orifices 39 for receiving the hooks of the other half-enclosure (FIG. 5).

The orifices 39 are cut into the flat edge 31. They are distributed along at least two opposite sides of the planar part 29, for example the sides that do not bear the slits 35. The hooks 37 are borne by the flat edge 31 and protrude away from the planar part 29 relative to the flat edge 31.

As shown in FIG. 7, they are generally L-shaped, with a segment 39 oriented substantially perpendicular to the flat edge 31, extended by a terminal segment 41 extending along a direction substantially parallel to the flat edge 31.

The terminal segments 41 of all of the tabs 37 point in the same direction.

The hooks 37 of each half-enclosure are provided to be engaged in the orifices 39 of the other half-enclosure following a movement substantially perpendicular to the planar parts 29 of the two half-enclosures. They are next engaged around the edges of said orifices 39 by a translational movement of one of the half-enclosures relative to the other half-enclosure along a longitudinal direction.

At the end of this movement, the flat edge 31 of each half-enclosure 27 is pinched between the terminal segments 41 and the flat edge 31 of the other half-enclosure 27. The hooks 37 can no longer be released from the orifices 39 by a movement perpendicular to the planar parts 29 of the half-enclosures.

At the end of this translational movement, the slits 35 of the two half-enclosures coincide with one another. The blocking members can be inserted into these slits and thus block any possibility of translation of the two half-enclosures, at least along the longitudinal direction, and typically along all directions, the latter then being solidly secured by the hooks.

In order to still further strengthen the connection between the two half-enclosures, additional hooks 43 are provided on a segment 45 of the flat edge extending transversely (FIGS. 5 and 8). These additional hooks 43 have a general shape that is substantially identical to that of the hooks 37. The additional hooks 43 are borne by the outer edge of this flat collar 31. Their terminal segments point longitudinally, along the same direction as the terminal segments 41 of the hooks 37. The transverse segment 47 of the flat edge 31, located opposite the transverse segment 45, has notches 49 on its outer edge. When the two half-enclosures 27 are assembled to one another as described above, namely a first movement perpendicular to the planar parts 29 and a second longitudinal movement, the additional tabs 43 of each half-enclosure engage in the notches 49 of the other half-enclosure and adapt around the transverse segment 47 of the other half-enclosure. The flat edge 31 of each half-enclosure 27 is thus pinched between the additional tabs 43 and the flat edge 31 of the other half-enclosure 27.

Thus, the two half-enclosures 27 are connected to one another by a particularly strong connection. The stiffness of the rearing enclosure is increased. This is in particular due to the existence of a large number of fastening points of the two half-enclosures 27 to one another, distributed around the upper and lower bottoms.

The connection 13 permits a rotation of each rearing enclosure 5 about a first, substantially horizontal axis of rotation R1, and a rotation of the first axis of rotation R1 with respect to the framework 3 about a second axis of rotation R2 substantially parallel to the first axis of rotation R1 (FIGS. 1 to 3).

More specifically, the connection 13 advantageously includes at least one connection member 51 of the connecting rod type, mounted pivoting on the rearing enclosure 5 about the first axis of rotation R1 and mounted pivoting on the framework 3 about the second axis of rotation R2.

As shown in FIG. 4, the connection 13 typically includes two connecting members of the connecting rod type 51 for each rearing enclosure, each connecting member 51 connecting the rearing enclosure 5 to the framework. The first axes of rotation R1 of the two connecting members of a same rearing enclosure are aligned with one another. Likewise, the second axes of rotation R2 of the two connecting members 51 of the same enclosure 5 are aligned with one another.

The rearing enclosure 5 has a proximal edge 55 and a distal edge 57 that are opposite one another, facing toward the two metal bars framing the rearing enclosure 5.

In the illustrated example, the proximal edge and the distal edge are longitudinal.

These edges 55, 57 are made up of segments of the flat collars 31 of the two half-enclosures pressed against one another.

The connection 13 connects the proximal edge 55 to the framework 3.

More specifically, each connecting member 51 connects the proximal edge 55 to the metal bar 17 adjoining said proximal edge.

As shown in FIGS. 4, 12 and 13, the connection 13 includes, for each connecting member 51, a sleeve 53 fastened to the metal bar 17 adjoining the proximal edge 55 of the rearing enclosure 5. The connecting member 51 is mounted pivoting around the sleeve 53. The metal bar 17 thus constitutes the second axis of rotation R2.

This sleeve 53 completely surrounds the metal bar 17. For example, it is made up of two generally semi-cylindrical half-shells, placed on either side of the metal bar 17. The two half-shells are rigidly fastened to one another using any suitable means, for example by pins. The sleeve 53 is typically made from polyolefin. The wear of the connecting member 51 is thus reduced, which is not in direct contact with the metal bar.

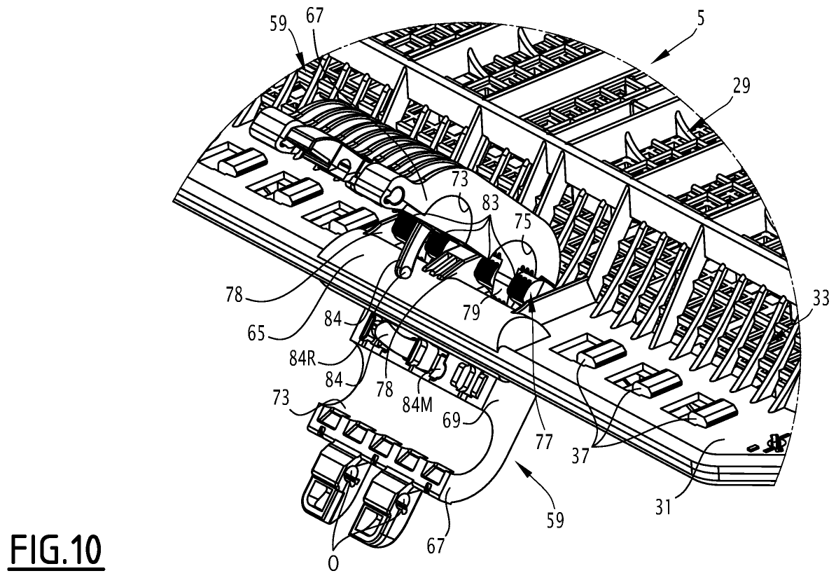

As shown in FIGS. 9 to 13, each connecting member 51 advantageously includes two half-clamps 59 that are independent of one another. The two half-clamps 59 together define two bearings 61, 63, which are substantially parallel to one another. The bearing 61 is intended inwardly to receive the sleeve 53. The bearing 63 is intended inwardly to receive a cylinder 65 formed on the proximal edge 55 of the rearing enclosure.

Each half-clamp 59 is therefore generally W-shaped, with three blocks 67, 69 and 71 delimiting two hollows 73 and 75 between them. The hollows 73 and 75 have semi-cylindrical shapes. When the two half-clamps are assembled to one another, the hollows 73 of the two half-clamps make up the bearing 61, and the hollows 75 of the half-clamps make up the bearing 63.

The two half-clamps 59 are able to be mounted on the rearing enclosure 5 in a stable open position, shown in FIG. 11, in which the half-clamps 59 are connected to one another by a pivot link 77.

The axis of rotation of the pivot is substantially parallel to the first axis of rotation.

To allow the two half-clamps to be placed, the proximal edge 55 of the trap has two orifices 78 along the cylinder 65. These orifices are offset toward the inside of the enclosure relative to the cylinder 65.

The pivot link 77 includes two plates 79, parallel to one another, formed on the block 71 of one of the half-clamps (FIGS. 5 and 9). Each plate 79 bears trunnions 81 on its two opposite faces. The four trunnions 81 are aligned.

The block 71 of the other half-clamp forms two pairs of flanges 83, each pair of flanges being provided to receive one of the plates 79 between its two flanges. Cradles for receiving trunnions 81 (not shown) are hollowed out in the opposite faces of the two flanges of a same pair.

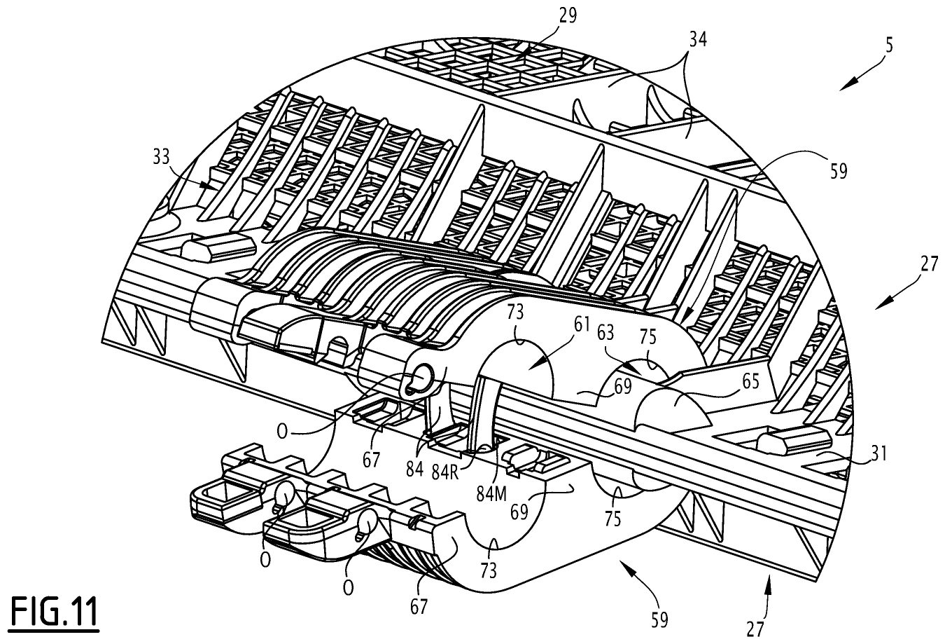

The half-clamps 59 are first mounted on the enclosure 5 as illustrated in FIG. 10.

One can see that the plates 79 are each engaged in one of the orifices 78. They are engaged between the flanges 83 of the other half-clamp 59. The half-clamps form an angle of about 90° with one another. The rotation of the two half-clamps relative to one another in the direction of an opening of the clamp is blocked by reliefs formed on the half-clamps 59. Conversely, the two half-clamps 59 are free to pivot relative to one another about the pivot link 77 in the direction of a closure. It should be noted that the cradles formed in the flanges 83 are provided so that the engagement of the trunnions 81 is easy, but the removal of the trunnions 81 outside the cradles requires a significant force, so as to prevent the two half-clamps from separating from one another involuntarily.

From the position of FIG. 10, the half-clamps 59 can pivot about the pivot link 77 to the stable open position, shown in FIG. 11. Each half-clamp 59 includes an arm 84, bearing a relief 84R at its end. In the open position, the relief 84R of each half-clamp is wedged reversibly in a housing 84M of the other half-clamp. This makes it possible to keep the half-clamps 59 in the open position, without preventing the rotational movement of the half-clamps toward one another from being extended.

Thus, from the stable open position (FIG. 11), the two half-clamps can be closed around the framework 3 by pivoting around the pivot link 77 (FIG. 12). The arms 84 slide through the housings 84M.

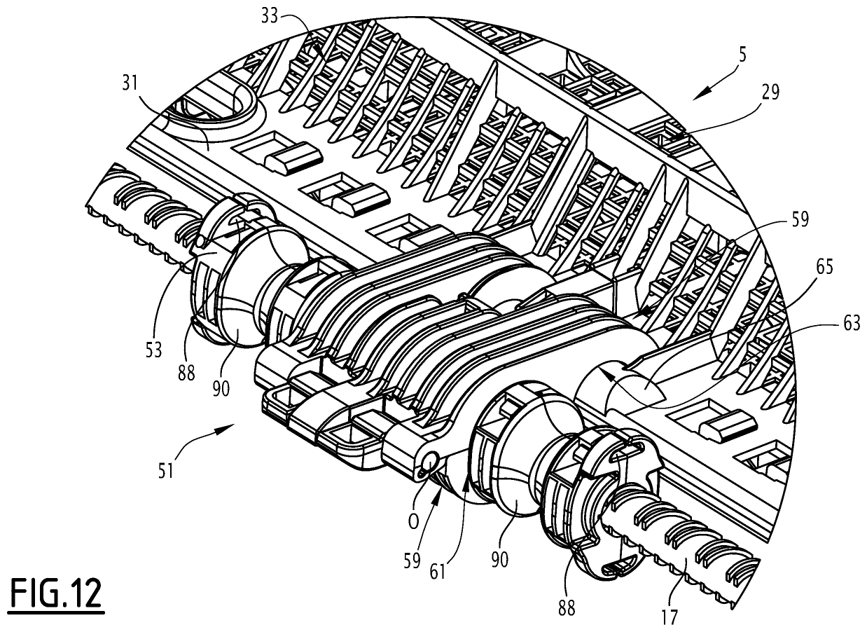

The hollows 75 are then placed around the cylinder 65, and the hollows 73 around the sleeve 53. In this position, the intermediate blocks 69 of the two half-clamps 59 bear against one another, and the blocks 67 of the two half-clamps 59 also bear against one another. The two half-clamps 59 are locked in this position by pins G shown in FIG. 13, engaged in aligned orifices O of the two half-clamps 59. It will therefore be understood that the mounting of the connecting member 51 is particularly simple. It allows an easy placement of the rearing enclosures 5 on the framework 3.

The rearing enclosure 5 preferably comprises at least one stop zone 85 (FIG. 14), cooperating with the connecting member 51 so as to limit the rotational travel of the rearing enclosure 5 relative to the connecting member 51 about the first axis of rotation R1.

Typically, the rearing enclosure 5 includes two stops zones 85, limiting the rotational travel of the rearing enclosure 5 relative to the connecting member 51 in both opposite directions of rotation.

These zones 85 are strengthened due to the fact that they include a larger number of ribs 34 than the other zones of the enclosure 5, so as to stiffen the structure of the rearing enclosure 5 at said zones 85.

For example, these zones 85 are the zones of the peripheral wall 33 located across from each connecting member. The zone 85 arranged on the peripheral wall 33 of one of the half-traps limits the rotation in one direction, and that formed on the wall 33 of the other half-trap limits the rotation in the other direction. These stops thus ensure an impact effect at the end of travel favoring the loosening and movement of the aquaculture animals on the tray.

Furthermore, the rearing device 1 advantageously includes a limiting device 86, limiting the travel of the rearing enclosure 5 relative to the framework 3 along the vertical direction (FIG. 4).

The limiting device 86 preferably comprises at least one flexible link 87 that connects the framework 3 to the rearing enclosure 5.

Preferably, the or each flexible link 87 is resilient. This makes it possible to damp the movement of the rearing enclosure in the vertical direction.

Typically, each rearing enclosure 5 is connected by two flexible links 87 to the framework 3.

Preferably, each flexible link 87 connects the distal edge 57 of the rearing enclosure 5 to the framework 3. More specifically, the link 87 connects the distal edge 57 to the metal bar 17 located opposite the connecting members 51. Thus, the rearing enclosure is connected on the one hand by the connecting members 51 to one of the metal bars 17, and on the other hand by the flexible links 87 to the other metal bar 17.

As shown in particular in FIGS. 4 and 5, the distal edge 57 has orifices 89 allowing the passage of the flexible link 87.

Typically, the ends of the flexible link 87 are fastened to the sleeve 53 on which the adjacent rearing enclosure 5 is hinged. As illustrated in FIG. 4, the ends of the flexible link 87 are wound around the sleeve, in grooves 90 formed by the sleeve 53.

The sleeves 53 can further include notches 88, visible in FIG. 12, making it possible to attach the flexible link to the sleeve.

It should be noted that the orifices 89 are identical and positioned in the same way as the orifices 78.

More generally, it will be noted that each half-trap is symmetrical relative to a longitudinal median plane, perpendicular to the planar part 29.

It is thus possible to mount the rearing enclosures in any direction.

In the first embodiment, each rearing enclosure 5 is equipped with its own float 11, which thus constitutes the float device 10. The float 11 is connected to a zone of the rearing enclosure 5 located near the distal edge 57.

Advantageously, as illustrated in FIG. 1, the float 11 is housed inside the rearing enclosure 5. It is fastened to the rearing enclosure 5 by any suitable means, for example by forming reliefs on the inner surface of the rearing enclosure, which keep the float 11 in place once the two half-enclosures 27 are engaged with one another.

The float 11 is dimensioned to cause the enclosure containing the aquaculture animals to float until the end of the rearing, that is to say, when these animals have reached their maximum weight.

The float device 10 can thus be adapted over the course of the rearing, for example by adding buoyancy as the mass of the aquaculture animals in the enclosures increases.

The operation of the rearing device will now be described in detail, more specifically in reference to FIGS. 1 to 3.

The device is designed to transmit the movement of the waves to the rearing enclosures, and will cause the aquaculture animals to slide over a significant distance by causing them to roll over the inner surface of the enclosure and against one another, in particular during falling and rising tide.

In FIG. 1, the device is shown when the water level is substantially at the level of the metal bars 17.

The inner bottom 23 is substantially horizontal.

The float device 10 is located at the surface of the water.

The two axes of rotation R1, R2 are substantially in a horizontal plane.

The flexible links 87 are not tensioned.

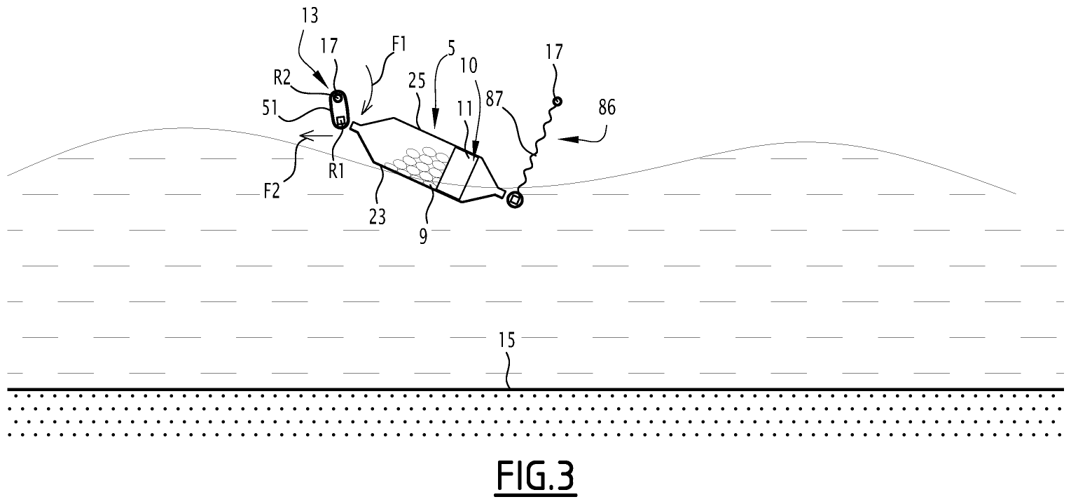

When the rearing enclosure is in a trough between two waves, as illustrated in FIG. 3, the vertical level of the float device 10 drops.

The rearing enclosure 5 adopts an inclined position, the proximal edge 55 connected by the connection 13 to the framework 3 remaining higher and the distal edge 57 being lower. The connection 13 permits the pivoting of the rearing enclosure 5 about the two axes of rotation R1 and R2.

Due to the incline, in particular because the lower bottom 23 is inclined relative to the horizontal, the rearing animals 9 will roll on the inner bottom 23 and will roll against one another while accumulating toward the distal edge 57 of the rearing enclosure.

Because the connection 13 has two degrees of rotational freedom, the downward pivoting movement of the rearing enclosure 5 (arrow F1 of FIG. 3) is accompanied by a generally horizontal movement of the enclosure 5, embodied by arrow F2 of FIG. 3. This generally horizontal movement creates a shearing force at the contact between the aquaculture animals and the rearing enclosure, which amplifies the circulation of the rearing animals and permits them to slide and roll even with small inclines. This shearing force, when repeated, potentially makes it possible to loosen any rearing animals that may be stuck to the rearing enclosure.

Thus, the connection 13 makes it possible to convert the vertical movement of the water, due to the waves, into an agitation movement that is both vertical and horizontal, which, associated with the incline of the rearing enclosure 5, permits the aquaculture animals to slide over the planar mesh of the enclosure while rolling over this mesh against one another.

Furthermore, the connecting members 51 at the end of travel abut against the stop zones 85 of the rearing enclosure, which further strengthens the shearing effect. This encourages the loosening of the rearing animals, in particular of the oysters that may have become stuck again by nacration between two agitation periods.

The limiting device 86 makes it possible to limit the vertical amplitude of the movement, which allows the farmer to adapt the system to the hydraulic conditions prevailing in the rearing zone and to the seasonality of the rearing.

It should be noted that the rearing enclosure 5 is driven in movements opposite those embodied by arrows F1 and F2 when the enclosure returns from its low position illustrated in FIG. 3 to the intermediate position illustrated in FIG. 1.

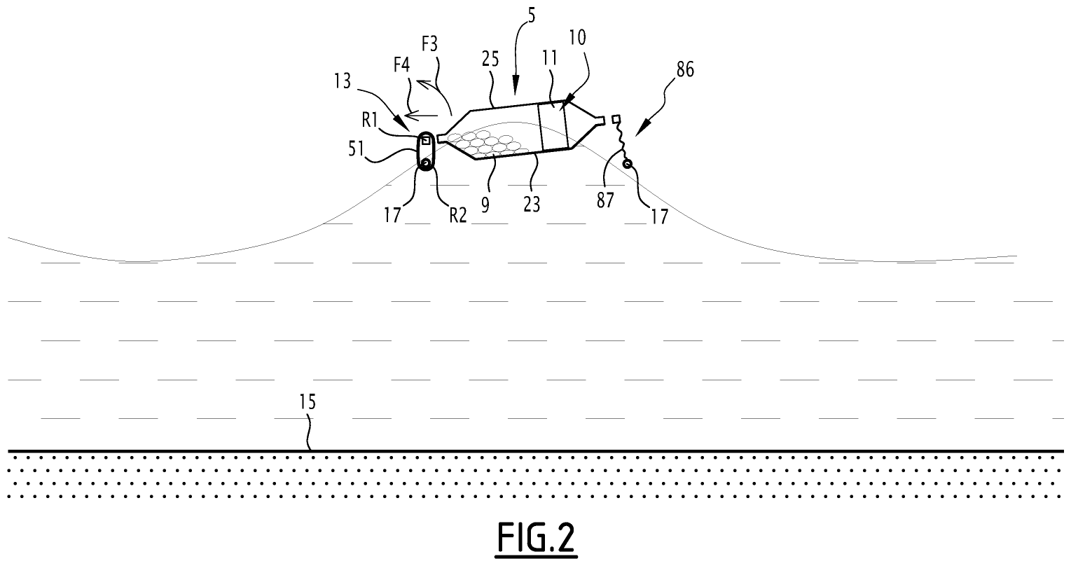

As shown in FIG. 2, when the rearing enclosure 5 is located at the top of a wave, the rearing enclosure 5 adopts an incline opposite that illustrated in FIG. 3. The distal edge 57 is located higher than the metal bar 17, such that the aquaculture animals 9 slide over the lower bottom 23 toward the proximal edge 55. The rearing enclosure undergoes a pivoting movement relative to the metal bar 17, embodied by arrow F3 in FIG. 2. This pivoting is done in an upward direction. Relative to the position of FIG. 1, the rearing enclosure 5 also experiences a movement in a generally horizontal direction, embodied by arrow F4 in FIG. 2. Again, a shearing force is created between the aquaculture animals and the rearing enclosure, which encourages the movement and the rolling of the rearing animals 9 within the rearing enclosure 5.

The connecting members 51 at the end of travel abut against the stop zones 85 provided to that end on the rearing enclosure 5. The limiting device 86 limits the upward vertical travel of the rearing enclosure 5 with respect to the framework 3.

The rearing enclosure 5 is driven in movements opposite those shown by arrows F3 and F4 when it returns from its extreme high position shown in FIG. 2 to the intermediate position illustrated in FIG. 1.

In the first embodiment, the rearing device 1 must be positioned on the tidal zone, such that the rearing enclosures 5 are located at the surface of the water at least at one moment during the tide.

Thus, the choice of the installation level of the rearing device in the tidal zone makes it possible to adapt the device to the tide conditions. Indeed, the tidal range is characterized by two parameters: its amplitude, variable from one day to the next (for example, in France, the strong tidal ranges alternate with the weak tidal ranges over a periodicity of 15 days) and the rising and falling speed of the water, which for example follows the rule of twelfths, which means that at the beginning or the end of the falling or rising tide, the rising and falling speed is three times slower than at mid-tide. As a result, depending on the altimetric installation of the float relative to the tidal range, it will be possible either to obtain, in the upper bracket of the low-amplitude tidal ranges, a daily agitation over a long duration, or to obtain, in the lower bracket of high-amplitude tidal ranges, a low to very low frequency agitation over a long duration, or in the in-between space of the tidal range, a more or less frequent agitation of shorter duration.

It should be noted that the limiting device 86 also makes it possible to adjust the amplitude and duration of agitation of the aquaculture animals, in order to regulate the desired effect on the rearing animals. Indeed, the rearing enclosures 5 are only agitated for a limited period of the tide. They are agitated between the moment where the peak of the waves reaches the low position of the rearing enclosure (shown in FIG. 3), and the moment where the trough of the waves exceeds the high position of the rearing enclosures (shown in FIG. 2). The greater the vertical amplitude of the movement of the rearing enclosures is, the greater the agitation duration and the more violent the agitation.

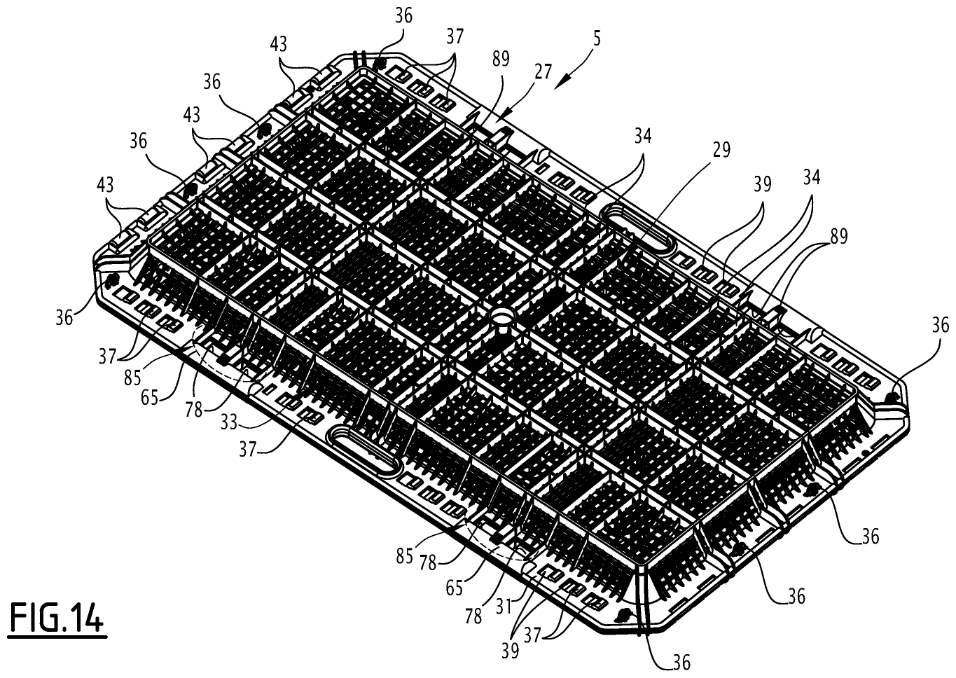

A second advantageous aspect of the first embodiment of the invention is shown in FIG. 15. As described above, the framework 3 includes a plurality of metal bars 17, parallel to one another and evenly spaced apart from one another. The metal bars 17 are for example fastened to metal crosspieces 90. Each rearing enclosure is positioned between two metal bars 17. Its proximal edge 55 is connected by the connection 13 to one of the metal bars 17, and its distal edge 57 is connected by one or several flexible links 87 to the other metal bar 17. The adjacent rearing enclosure 5 is mounted in the same way. More specifically, the distal edge 55 of the adjacent rearing enclosure 5 is connected by the connection 13 to the metal bar 17 to which the first rearing enclosure is connected by the flexible link(s) 87. Thus, each metal bar 17 is connected on the one hand by a connection 13 to a rearing enclosure 5, and on the other hand by flexible links 87 to another rearing enclosure.

A continuous line of rearing enclosures 5 is thus formed. The rearing enclosures 5 can be turned over very easily to combat dirtying. Indeed, it is known that algae develop very easily on the faces of the rearing enclosures that face upward, that is to say, that are exposed to the sun. Furthermore, ascidians develop on the face of the rearing enclosure that is in the shade, that is to say, facing downward.

In order to turn over the rearing enclosures of the device according to the invention, it suffices to disconnect the links 87 connecting each rearing enclosure to the corresponding metal bar 17. It is next possible to pivot the rearing enclosure 5 about the other metal bar, to which it is connected by the connection 13. Then, the distal edge of the enclosure is connected to a new metal bar 17, by the resilient links that have stayed in place.

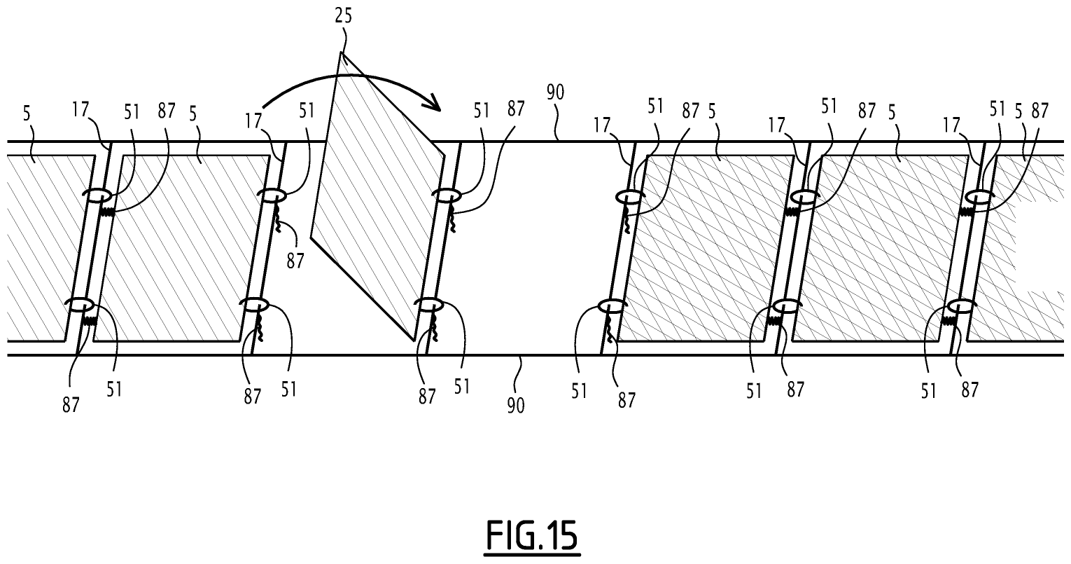

A second embodiment of the invention will now be described in reference to FIGS. 16 to 19. Only the differences between the second embodiment and the first will be outlined below.

In the second embodiment of the invention, all of the rearing enclosures 5 of the rearing device 1 are connected to a same float device 10.

Advantageously, the framework 3 comprises several metal bars 17 that are parallel to one another, spaced apart from one another at least vertically.

For example, the framework 3 includes a parallelepiped structure. This structure includes four vertical posts 91, these posts preferably being secured to one another by an upper frame 93 and a lower frame 94. The metal bars 17 are rigidly fastened by their opposite end to two of the posts 91, and are superimposed along the vertical direction. The metal bars 17 are thus positioned on a large face of the rhomb.

A rearing enclosure 5 is connected to each metal bar 17, the rearing enclosures 5 being superimposed above one another.

The metal bars 17 are evenly spaced apart from one another along the vertical direction.

The rearing enclosures 5 are placed inside the framework, and travel between the posts 91.

According to one exemplary embodiment, the float device 10 includes a single float 11. The float device 10 is connected by a flexible connection 95 to the upper rearing enclosure 5, located highest in the stack of rearing enclosures.

The flexible connection 95 is of any suitable type. The flexible connection 95 for example includes one or several cables, each connecting the float to the enclosure. In a variant, it includes lines, ropes, chains, or any other type of flexible link.

Intermediate connections 97, typically cables or lines, link each rearing enclosure 5 to the rearing enclosure located immediately above and/or the rearing enclosure located immediately below in the stack. In a variant, these intermediate connections are rigid spacers, which for example pivot about axes located on the distal edge of the rearing enclosures. Indeed, a rigid connection can be a cohesion factor of the movement encouraging an equal agitation of the set of rearing enclosures. In some cases, a flexible connection could, in case of high-frequency agitation (chop), encourage, following the inertia of the set of rearing enclosures, the agitation of the upper rearing enclosures, resulting in an excessive agitation of the rearing animals of the upper enclosures versus an insufficient agitation of the rearing animals of the lower enclosures.

Typically, the flexible connection 95 connects the float device 10 to the distal edge 57 of the upper rearing enclosure. The intermediate connection(s) 97 connect the distal edges of the different rearing enclosures to one another.

The rearing device according to the second embodiment of the invention is designed to be able to be used in deep water, that is to say, in a zone where the rearing enclosures 5 are not exposed at low tide.

The framework 3 rests on the bottom 15. It is for example mounted on a pile driven into the bottom 15.

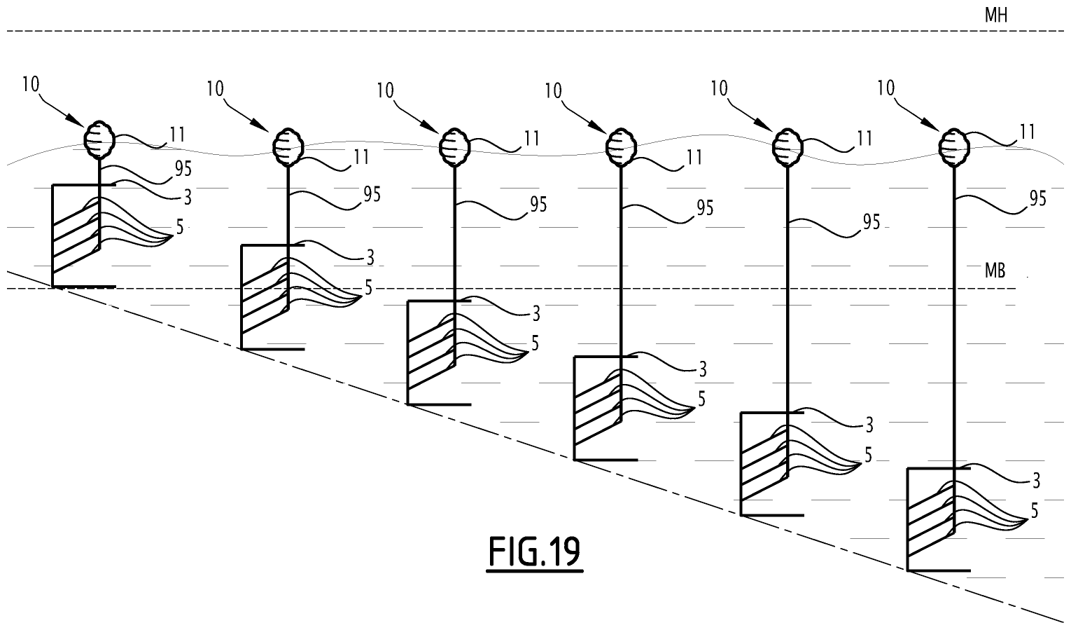

The length of the flexible connection 95 is chosen such that the float device 10, when the flexible connection 95 is tensioned, is in the intertidal zone, that is to say, a level between the level of the water at low tide (MB in FIG. 19) and the level of the water at high tide (MH in FIG. 19).

In other words, the length of the flexible connection is chosen so that, at least at one moment during the cycle of the tide, the float device 10 floats on the surface of the water with the flexible connection 95 tensioned, such that the movements of the water due to the waves are transmitted by the float device 10 and the flexible connection 95 to the upper rearing enclosure.

The intermediate connections 97 are chosen with lengths such that, when the upper enclosure 5 pivots upward, it drives the enclosure located immediately below it, which in turn drives the immediately lower enclosure, etc.

Typically, the length of the intermediate connections 97 is chosen to be equal to the vertical separation between the metal bars 17.

In the illustrated example, the float 11 is connected to the upper rearing enclosure by two cables. Each rearing enclosure is connected to the enclosure immediately above and/or the enclosure immediately below by two intermediate connections 97.

Furthermore, the limiting device 86 comprises at least one flexible link 99, connecting the upper rearing enclosure to the framework and limiting the travel of said enclosure in the downward direction. In the illustrated example, the limiting device 86 comprises two flexible links 99, connecting the upper enclosure to the framework.

Advantageously, the limiting device 86 comprises at least one flexible link 101 connecting the lower enclosure 5, located below the stack of enclosures, to the framework and limiting the travel of the lower enclosure in the upward direction. In the illustrated example, the limiting device 86 comprises two flexible links 101 connecting the lower enclosure to the framework 3.

It should be noted that the flexible links 101 could not be mounted on the lower enclosure 101, but be mounted on any other enclosure of the stack.

The operation of the rearing device according to the second embodiment will now be described.

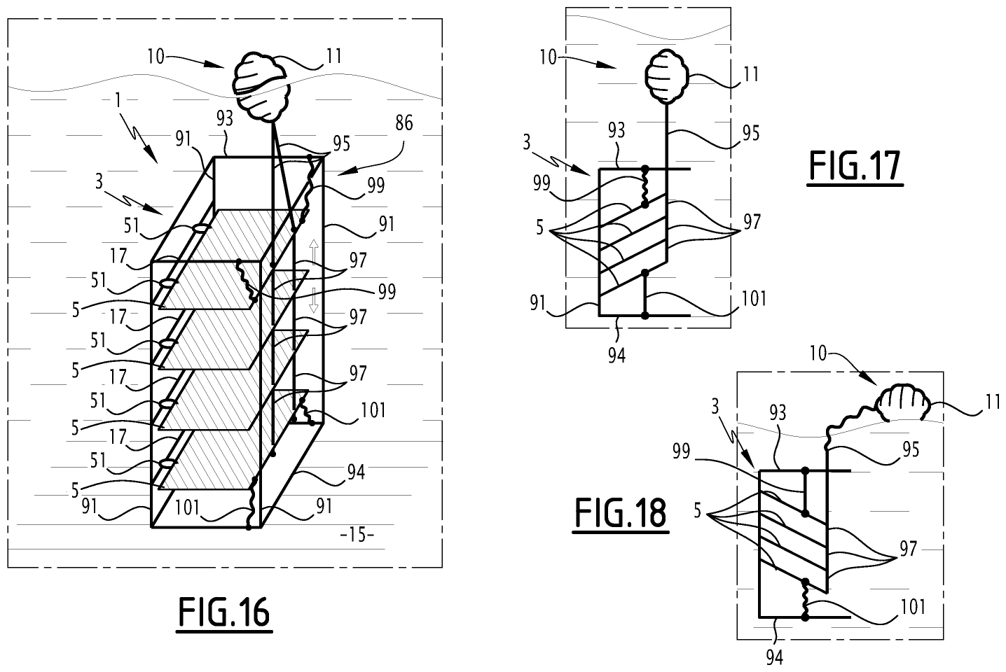

When the tide is high, as illustrated in FIG. 17, the float device 10 is completely submerged, and is at a distance from the water level. The flexible connection 95 is tensioned. The rearing enclosures 5 are in their extreme high positions. This position is defined by the limiting device 86.

In the exemplary embodiments described above, this position is defined by the length of the flexible link(s) 101, which are also tensioned.

The float device 10 urges the upper rearing enclosure 5 upward, this urging being transmitted by each rearing enclosure 5 to the rearing enclosure immediately below it through the intermediate connections 97.

When the sea is at an intermediate level between the high tide and the low tide, as a function of the length of the flexible connection 95, the situation illustrated in FIG. 14 is encountered. The float device 10 floats on the surface of the water, the flexible connection 95 being tensioned. The vertical movement of the water created by the waves causes a vertical movement of the float device 10. When the float device 10 moves upward, it drives the upper rearing enclosure 5 through the flexible connection 95, which in turn drives the enclosures located below upward through the intermediate connections 97.

This upward vertical movement is limited, if applicable, by the limiting device 86. In the exemplary embodiment described above, the upward movement is limited by the flexible links 101.

When the water level drops, the float device 10 is driven downward. This gives slack to the flexible connection 95, and the enclosures 5 are driven downward under the effect of their own weight. The downward movement of the upper enclosure 5 is limited, if applicable, by the limiting device 86. In the exemplary embodiment described above, the downward movement is limited by the flexible link(s) 99. The downward movement of each rearing enclosure 5 relative to the upper enclosure is limited by the length of the intermediate connections 97.

When the tide is low, the rearing device is in the situation illustrated by FIG. 18. The rearing enclosures 5 are in their extreme low position, defined by the limiting device 86. In the exemplary embodiments described above, this position is defined by the length of the flexible link(s) 99 and by the length of the various intermediate connections 97. The float device 10 floats on the surface of the water. The flexible connection 95 is not tensioned.

As indicated above, the second embodiment of the invention is particularly advantageous because it makes it possible to position the rearing device in deep water, in locations never exposed at low tide. It therefore makes it possible to use zones that are not usable with the device according to the first embodiment of the invention.

The installation level of the float device 10 relative to the height of the tidal range, that is to say, the height of the water at high tide and the height of the water at low tide, makes it possible to choose the operating conditions of the system.

Thus, as previously described, the choice of the length of the flexible connection 95 makes it possible to adapt the device to the tidal conditions. Indeed, the tidal range is characterized by two parameters: its amplitude, variable from one day to the next (for example, in France, the strong tidal ranges alternate with the weak tidal ranges over a periodicity of 15 days) and the rising and falling speed of the water, which for example follows the rule of twelfths, which means that at the beginning or the end of the falling or rising tide, the rising and falling speed is three times slower than at mid-tide. As a result, depending on the altimetric installation of the float device relative to the tidal range, it will be possible either to obtain, in the upper bracket of the low-amplitude tidal ranges, a daily agitation over a long duration, or to obtain, in the lower bracket of high-amplitude tidal ranges, a low to very low frequency agitation over a long duration, or in the in-between space of the tidal range, a more or less frequent agitation of shorter duration.

Furthermore, the amplitude of the movements, and the duration of the agitation periods, can also be adjusted by the limiting device 86. In the exemplary embodiment described above, this adjustment is done by choosing the length of the flexible links 99 and 101.

The second embodiment of the invention can also be applied with rearing devices positioned on the tidal zone, when one wishes to set a superposition of enclosures in motion and/or to work with the same tide level over the entire surface of the tidal zone. This allows the farmer to make zootechnical choices: agitation frequency, amplitude of the movement, agitation duration.

As illustrated in FIG. 19, several devices like those described in FIG. 16 can be positioned on the tidal zone at different depth levels, the float devices 10 of the various devices being adjusted to be placed substantially at the same level. Thus, the flexible connections 95 of the various devices have variable lengths, as illustrated in FIG. 19. These lengths are chosen so that the respective flexible connections of the various devices are tensioned for substantially the same water level.

A third embodiment, not shown, will now be described. Only the differences between the third embodiment and the first embodiment will be described in detail below.

In the third embodiment, the float device 10 is not housed inside the rearing enclosure. On the contrary, the float device 10 is placed outside the rearing enclosure and is connected by a flexible connection 95 to the rearing enclosure 5.

Like in the second embodiment, the length of the flexible connection 95 is chosen such that the float device 10, when the flexible connection 95 is tensioned, is in the intertidal zone.

The rearing enclosures 5 can thus be positioned outside the tidal zone, in deep water.

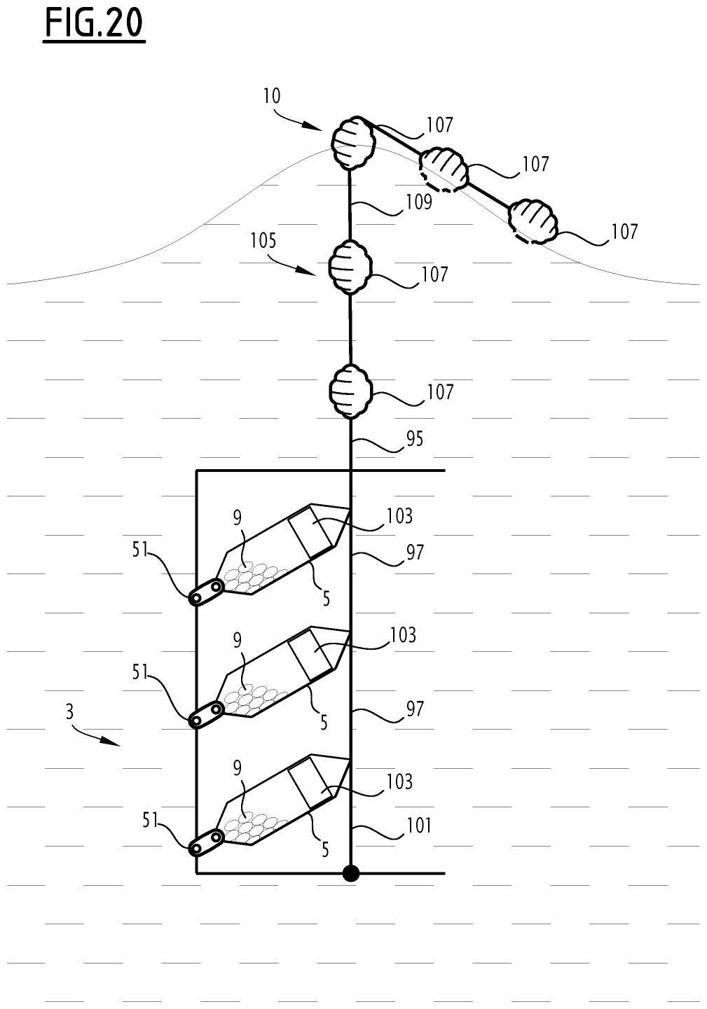

It should be noted that, in the second and third embodiments of the invention, each rearing enclosure is, in a variant, equipped with its own float 103, in addition to the float device 10. Such a situation is illustrated in FIG. 20. The floats 103 are for example positioned in the enclosures 5. They are sized to at least partially compensate for the mass of the aquaculture animals at the end of rearing. This makes it possible to limit the buoyancy of the float device 10 necessary for the movement, and therefore the forces transmitted by the float device 10 installed in the interval of the tidal range in case of storm, for example. This aspect is very important, because the cumulative effect of the floats depending on their number, arrangement and volume, leaves the farmer the possibility of definitively determining the ideal assembly perfectly adapted to his deep water site, knowing that the hydrodynamic conditions are invariable, while taking account of the storm risks, and therefore allowing him to consistently and regularly obtain the quality of product that he has chosen.

According to another embodiment variant applicable to the second and third embodiments, the float device 10 comprises not a single float, but a string 105 of floats. Such an arrangement is illustrated in FIG. 20. This string 105 includes a plurality of floats 107, mounted one after the other along a flexible link 109, a lower end of which is secured to the flexible connection 95.

Advantageously, the volume, and therefore the buoyancy, of the floats 107 increases from the upper end to the lower end of the flexible link 109.

Such an arrangement allows a progressive, gentler and therefore longer action in the interval of the chosen tidal range.

This variant can be combined with the previous one (float 103 specific to each enclosure in addition to the float device 10).

According to a variant applicable to all of the embodiments, the connection 13 is not mounted on the proximal edge of each rearing enclosure 5. If one considers the median plane of the rearing enclosure 5, perpendicular to the lower bottom and parallel to the axes of rotation R1 and R2, the connection 13 can connect any point located on one side of this median plane to the framework 3. The float 11 is preferably connected to any point located on the other side of the median plane.

Likewise, the flexible links can be connected to any point of the enclosure located on the side of the median plane opposite the connection 13.

The invention has been described for a device in which the rearing enclosures 5 are connected to the framework by connecting members of the connecting rod type, creating a shearing force between the aquaculture animals and the enclosure under the effect of the vertical movement of the enclosures. However, the invention is also applicable to rearing enclosures connected to the framework by simple pivoting links about a single axis of rotation, as described in FR 2,576,484, or two systems of pivoting trays on which the rearing enclosures are placed, or to systems of cages containing many enclosures, said cages being able to pivot around an axis so as to ensure a movement of the enclosures similar to that previously described.

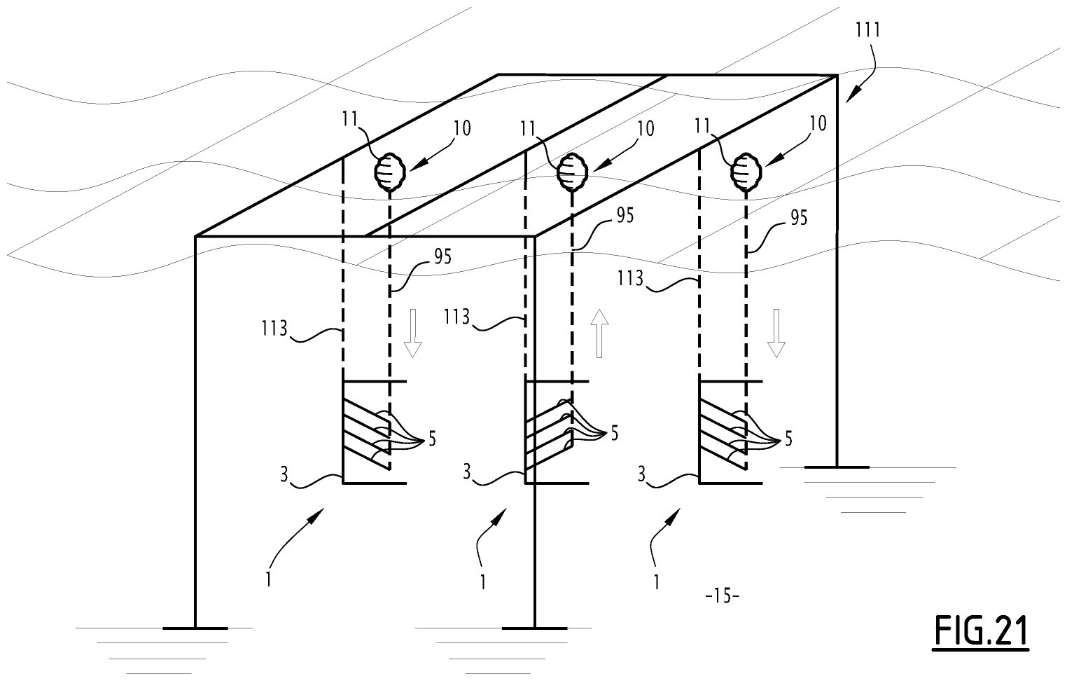

Another embodiment variant will now be described, in reference to FIG. 21. It is applicable to all of the embodiments previously described.

In this embodiment variant, the framework 3 does not rest directly on the sea bed 15. The framework 3 is located slightly above the sea bed 15. It is for example mounted on a carrier structure 111, which rests securely on the sea bed 15.

The carrier structure 111 is of any suitable type: table, gantry, etc.

It is rigidly fastened on the sea bed, or on the contrary is only ballasted so as to stay in place due to its own weight.

The carrier structure 111 bears one or several rearing devices 1. Each framework 3 is mounted on the carrier structure 111 by any suitable means: rigid metal bars 113, direct welds, flexible metal cables, etc.

According to one exemplary embodiment, the limiting device 86 includes stationary stops to replace or in addition to the flexible links 87, 99, 101.

These stationary stops are rigidly fastened to the framework 3. Some of the stops limit the upward travel of the or each rearing enclosure 5 relative to the framework 3, and other stops limit the downward travel of the or each rearing enclosure 5 relative to the framework 3.

In the second embodiment, the stops are advantageously metal bars rigidly fastened to the framework, above and below the stack of rearing enclosures.

Such an arrangement is particularly well suited when the rearing enclosures are placed on pivoting trays connected to the framework.

It should be noted that the combination of four complementary technical aspects makes it possible to obtain particularly interesting results. These four aspects contribute to imparting a shearing movement very effectively to the aquaculture animals that makes it possible to roll them over a surface and against one another so as to obtain a limitation of the growth by sequential rupture of the lace forming by strong fattening, cleanliness and shell shape that are irreproachable.

These four technical aspects are as follows.

1. The use of an enclosure having an extensive and planar rearing surface for the aquaculture animals.
2. The use of a float device directly or indirectly connected to the enclosure that follows the sea level when the tide is at the level of the float device, transferring an incline variation from top to bottom and from bottom to top to the enclosure when the sea rises and falls, such that the aquaculture animals slide over the rearing surface; if applicable, the enclosure also follows the undulating movement of the waves, thus reducing the preceding movement and, if applicable, when the enclosure itself emerges, creating, owing to its bottom surface thus positioned at the air/water interface experiencing the effect of the wave striking the bottom of the enclosure, creates a washing effect by the water splashing through the meshes of the enclosure with an overpressure (well-known blowing effect of the waves in the rocky cavities on the seaside). This effect is particularly strong when the enclosure has a wide and flat lower surface, according to one favored embodiment of the invention.
3. The use of a fastener fastened on two axes, one on the enclosure and the other on the support of the enclosure, thus forming a connecting rod that converts the upward/downward movement created by the flow device into a shearing movement encouraging, in favor of their inertia, the movement of the aquaculture animals over the planar surface of the enclosure; this encourages the loosening of the aquaculture animals stuck on the enclosure by nacration during the tide periods without agitation of the enclosures.
4. The use of a limiting device making it possible to limit the vertical amplitude of the upward/downward movement due to the flow device in order to limit the preceding effects as a function of the zootechnical needs.

A synergy exists between these technical aspects, making it possible to achieve particularly good results.

However, it is not necessary to implement these four technical aspects jointly. In the present patent application, aspects 2. and 4. are claimed jointly and make it possible to obtain excellent results for the adaptation of the system to the rearing conditions. The implementation of aspects 1. and/or 3., in addition to aspects 2. and 4., further improves the results.

A parallel patent application protects the joint implementation of aspects 2. and 3.

Still another patent application protects the implementation of aspect 2. for enclosures submerged in deep water, inasmuch as the float device is positioned in the intertidal zone.

1. A device for rearing aquaculture animals at sea, the device comprising:
a framework;
at least one rearing enclosure internally delimiting a volume for receiving aquaculture animals;
a float device connected to said at least one rearing enclosure;
a connection connecting said at least one rearing enclosure to said framework, permitting a rotation of said at least one rearing enclosure with respect to said framework about at least one substantially horizontal axis of rotation; and
a limiting device limiting travel of said at least one rearing enclosure relative to said framework along the vertical direction.

2. The device according to claim 1, wherein said limiting device comprises at least one flexible link connecting said framework to said at least one rearing enclosure.

3. The device according to claim 2, wherein said at least one rearing enclosure comprises a proximal edge and a distal edge that are opposite one another, and wherein said connection connects said proximal edge to said framework.

4. The device according to claim 3, wherein said float device is connected to a zone of said at least one rearing enclosure located near said distal edge.

5. The device according to claim 3, wherein said framework comprises several metal bars parallel to one another and spaced apart from one another at least horizontally, wherein said at least one rearing enclosure comprises several rearing enclosures each positioned between two of said metal bars, wherein said connection connects said proximal edge to one of the two metal bars, and wherein said flexible link connects said distal edge to the other of the two metal bars.

6. The device according to claim 2, wherein said framework comprises several metal bars parallel to one another and spaced apart from one another at least vertically, and wherein said at least one rearing enclosure comprises several rearing enclosures located one above the other, each connected to one of said metal bars, and wherein all of said rearing enclosures are connected to said float device.

7. The device according to claim 6, wherein a flexible link connects the uppermost rearing enclosure to said framework, limiting downward travel of said rearing enclosures.

8. The device according to claim 6, wherein a flexible link connects one of said rearing enclosures to said framework, limiting upward travel of said rearing enclosures.

9. The device according to claim 1, wherein said connection permits a rotation of said at least one rearing enclosure about a first, substantially horizontal axis of rotation, and permits a rotation of the first axis of rotation with respect to said framework about a second axis of rotation substantially parallel to the first axis of rotation.

10. The device according to claim 9, wherein said connection comprises at least one connection member of the connecting rod type, mounted pivoting on said at least one rearing enclosure about the first axis of rotation and mounted pivoting on said framework about the second axis of rotation.

11. The device according to claim 1, wherein said at least one rearing enclosure comprises a substantially flat lower bottom, parallel to the first and second axes of rotation.

12. The device according to claim 2, wherein said at least one flexible link is resilient.

13. The device according to claim 3, wherein said at least one flexible link connects said distal edge to said framework.
